(19) United States
(12) Patent Application Publication
(10) Pub. No.: US 2005/0154796 A1
(43) Pub. Date: Jul. 14, 2005

(54) Method of enabling a wireless information device to access data services

(76) Inventor: John Matthew Forsyth, London (GB)

Correspondence Address: Richard C Woodbridge;Synnestvedt Lechner & Woodbridge, P O Box 592, Princeton, NJ, 08542-0592, US

(21) Appl. No.: 10/506,841

(22) PCT Filed: Mar. 6, 2003
(86) PCT No.: PCT/GB03/00947

(30) Foreign Application Priority Data
Mar. 6, 2002 (GB) 0205130.8

(51) Int. Cl. G06F 3/00

(52) U.S. Cl. 710/1

(57) ABSTRACT

A method of providing data to a wireless information device, in which data supplied from a remote service provider is represented by an icon which is (a) automatically displayed within an application running on the device, and which (b) changes if the data alters, in order to alert the user to new data or to represent that new data. For example, a weather icon could be displayed in a calendar application if the device is being supplied or can access weather data. The weather icon changes dynamically to represent the weather on the particular day in the calendar; perhaps tomorrow's predicated weather

### BACKGROUND OF THE INVENTION

1. Field of the Invention

This invention relates to a method of enabling a wireless information device to access data services, particularly from several data services providers. The term ‘wireless information device’ used in this patent specification should be expansively construed to cover any kind of device with one or two way wireless information capabilities and includes without limitation radio telephones, smart phones, communicators, personal computers, computers and application specific devices. It includes devices able to communicate in any manner over any kind of network, such as GSM or UMTS, CDMA and WCDMA mobile radio, Bluetooth, IrDA etc. It further includes a device which is not a single, unitary device of the type defined above, but instead comprises multiple separate devices communicating with one another over a short range wired or wireless network. An example would be a wireless information device which comprises a personal communications ‘hub’ device which handles communications functions and a separate device wirelessly connected to the hub and which enables user interaction by providing a display etc. A data service provider is an entity which supplies information of interest to a user; the term encompasses commercial entities, as well as individuals.

2. Description of the Prior Art

History of Wireless Data Services

The story of data services to date has been one of mixed fortunes. In Japan, iMode services have been regarded as a spectacular success. Approximately 18% of revenues to DoCoMo in 2001 (source DoCoMo) will be due to non-voice traffic with some 65% of these attributable to content-based services. In contrast, WAP technology has failed to make a significant impact in Europe or in the USA despite very substantial investments in infrastructure and marketing.

Analysts are not all agreed about the reasons for the difference. Certainly some of the reason is down to cultural issues and DoCoMo's ability to mandate a standard through sheer market power. But there is another factor—the WAP devices were marketed as the “Mobile Internet” which raised unrealistic expectations that were far from the ability of the technology to deliver. Many of these issues have subsequently been addressed but the services have not as yet recovered. Some of the remaining issues for WAP include:
Slow—It takes a long time to acquire data. Contrary to popular belief, this is mainly an issue of network latency rather than bandwidth. Later networks (e.g. GPRS) do not necessarily improve this significantly.
Expensive—Because the technology is based on data over a conventional phone call, the user is faced with normal mobile phone charges even when reading content. GRPS provides an opportunity to fix this.
No value chain for content providers—Content providers have no way of making a small charge for content. This makes it difficult to create a business case for WAP content, except for major purchases (via credit card) which are not well suited to the phone device.
Poor user experience—Poor device displays lead to unattractive content (text only) and very deep menu tree structures to access information. As a result it takes many clicks (and many delays) to get to the information the user wants by which time many users will have given up (reports suggest that for every click required 25-50% of potential customers are lost).
Incompatible client devices—different devices support different features or interpret features differently, making it difficult for content providers to target all devices.

Next generation networks will address some of these issues. GPRS will allow a more flexible pricing structure and new billing systems presently being installed by the network operators will make it much simpler for operators to charge small amounts for individual services. In addition, there are signs that the operators will begin to offer a proportion of incremental call revenue to portals and service providers.

Next generation phones will also help. Larger displays and increased processing power will make it easier for the user to access data. In addition, there is a move towards standardisation of device capabilities so that content will work on multiple devices. Nevertheless, devices will vary considerably in capability (screen sizes, supported technologies etc) and a “one size fits all” data format seems unlikely. In addition, any standardisation of capability tends to a lowest common denominator approach and so manufacturers tend to add their own enhancements in order to make their offerings more attractive. This makes it difficult for content providers in the absence of any dominant designs in the market.

Making a Phone Compelling

Mobile phones are characterised by mobility, communication, small screens, and limited input capability (phone keys). The usage model is very different to that of the PC—services on a phone are about short transactions that help the user in context—send a short message, take a picture at a party and mail it to a friend, see what the weather will be like this afternoon, find your way in a street, pay for a cola, check out your stars, read a joke. Unfortunately the browsing model does not translate well onto the mobile phone and the improvements to networks and devices of themselves will only marginally improve the usability of the devices. This is exemplified by the present portal model which is intended to provide a natural gateway to users but is not presently seen as widely attractive in the market.

In order to attract users, the information they need must be integrated into the handset in a seamless way. Some of this information will be pulled (user searches for the content) and some pushed (the content arrives at the user's device). The latter is seen as a key to new services such as content that arrives when the user is close to a certain place or at a certain time. An example would be an offer of a half price drink in an airport lounge while waiting for a flight but might just as easily be the latest score in a football match or a share price. While some of this content will be wanted, there will be times when it is inappropriate and inevitably there will be a trend towards SPAM content to which market research suggests users have a very low tolerance. This is bad enough if it clogs up an email in-tray but if it alerts the user as well it will be infuriating. Furthermore, if the user has effectively paid for the content to be delivered, the reaction is likely to be very negative. Indeed, governmental bodies such as the European Commission and, in the United Kingdom, the Advertising Standards Authority, are considering measures to ban publication of content without explicit consent from the recipient. This limits SPAM but does not address the problem of receiving worthwhile services in context.

Requirements for a Compelling Service

In addition to the capabilities of the emerging devices and networks, the following will be required to make services compelling:
Easy access to information—typically no more than 2 “clicks” away and simple content is “always on” (e.g. a current weather icon or football score)
Presentation of the most likely content—taking account of the user's context (location, time, . . . )
Put the user in control with a simple interface—interruptions only occur when desired

For the content providers, there is a requirement for:
A defined value chain and billing system that generates revenue
Ideally a standardised target platform so that content can be published without regard for the user's device
The principal provider (e.g. a network operator) wants to be able to make their presence more apparent to the user i.e. device customisation depending on the provider. This supports the brand, increases traffic to the providers sites and (through use of the services and the associated investment in learning how they work) increases customer loyalty.
Identifying content that will maximise revenue (particularly true for content that is pushed speculatively since, unlike the PC Internet world, pushing content costs money in a mobile phone)

Some of the above requirements are addressed in PCT/GB01/03788 to Symbian Limited. The present invention introduces supplemental concepts to those described in PCT/GB01/03788.

### SUMMARY OF THE PRESENT INVENTION

The present invention is a method of displaying data on a wireless information device, in which data supplied from a remote data supplier is automatically displayed within an application running on the device, and changes to alert the user to new data or to represent that new data; characterised in that the device is programmed to present a menu list of the different data types already stored on the device and potentially available within a given application, such that selecting a particular data type from the menu list causes data of the selected type to be automatically displayed within that application.

The application in which the displayed data is automatically embedded is not an application that is dedicated to data acquisition from servers remote from the device, such as a messaging application for push e-mail or a web or WAP browser. Instead, it enables the device to display and manipulate data of a different kind from the data associated with the data from the remote service provider. The application hence provides appropriate and relevant factual information (or ‘context’) in which to automatically embed the data, which may be represented as an icon. For example, a weather icon could be displayed in a calendar application if the device is being supplied or can access weather data. The weather icon changes dynamically to represent the weather on the particular day in the calendar; perhaps tomorrow's predicted weather: this is an example of a weather data service being pushed to an end user device, but because the information is automatically displayed in an appropriate context, the user has no need to browse to it. Further, because the icon is dynamic, up to date information is automatically displayed on the device. Hence, the weather icon could change from an icon of rain showers to an icon of a sun to indicate that the weather is now being predicted to be likely to turn sunny tomorrow. Clicking on the weather icon causes a new application to be launched that takes the user to more detailed weather information. This additional information could have been already sent to the device, or be downloaded to the device from a nearby device, or over a WAN, the downloading being triggered by the user clicking on the weather icon. The user may well pay a small sum (charged automatically to the phone bill) for this additional information.

Another example could be traffic information; this could be automatically incorporated into a mapping or navigation application by, for example, including an icon indicative of heavy congestion over affected roads. Hence, the appearance of the specific ‘congested traffic’ icon over a road shown on the map alerts the user to the congestion. Combining the two applications, weather icons could be overlaid onto a map displayed within the mapping or navigation—e.g. sun icons over London and Manchester and a rain icon over Birmingham to indicate the current weather conditions there The same data can hence be presented within several different applications; in the above example, weather data being used automatically within both a calendar application and also a mapping application, with ‘dynamic’ weather icons automatically embedded within the images generated by each application. Further, the data (e.g. weather data) could be a software object (as that term is understood in object based programming) and the icon is then a sub-set of the object; any given object could then have multiple different icons. The object could, as noted above, be accessed by several different applications. Also, the object could have several different data variables associated with it (e.g. for a weather object, these could be current temperature, pollen count, links which if selected cause other objects to be downloaded to the device or other applications on the device to open etc.) Different applications could then use different data variables of the same object. The object based approach has several advantages. For example, object based data could attach to pre-existing or native objects in an application: imagine that the calendar application uses an ‘anniversary’ object, which is associated with events that happen once a year. The data object of which the dynamic icon is a sub-set could then attach to an anniversary object: it could be a service from a florist, so that whenever the user opened a day in the calendar in which someone's birthday was noted (and associated with an anniversary object type), then a flower icon could flash next to the birthday entry. Selecting the flashing flower icon would then open up a messaging application with a message to the on-line florist allowing the user to easily order flowers to be sent.

Another example is a personal finance or electronic money application; then, a bank could for example push personal statements to the users' wireless information devices as represented by a small icon that is automatically embedded into the personal finance/electronic money application user interface. The icon could be the trade mark/logo of the bank. When the user's balance changes, the icon could change, perhaps rotating or flashing or, more literally, could have a word based alert associated with it (e.g. “New”). The user could then, if it wished, click on the logo to trigger an actual local accessing or download of the new statement, which would then automatically be displayed and also stored in the relevant database(s) in the personal finance application. Alternatively, the bank could choose to send the actual account balance values to users' devices, with the actual money amount in figures automatically populating the appropriate account balance field within the personal finance application. The balance amount would then change as and when the device received updating balance information. In this case, the icon is not a small, stylised representational graphic, but instead actual text.

The term ‘icon’ should therefore be expansively construed to cover small, stylised representational graphics, small images (e.g. photographic thumbnails, which are not stylised representational graphics per se), text, or any combination of these. Icons can appear in several ways in an application, such as being apparent from the main view of the application (e.g. a ‘cloud’ icon at the top of calendar entry for a day, indicating the predicted weather for that day). Icons can also be embedded in control lists, such as menu lists or dialogs. One application of this could be to automatically embed new ringtones within the list of available ringtones on a device; these newly embedded ringtones could be differentiated from existing ringtones so that the user knew they had not yet been paid for (e.g. through the words ‘sample’, or making them flash etc.). The user can then easily sample the ringtone; if he decides to activate the ringtone, he can be charged by the supplier.

The present invention envisages in one implementation a form of real time push information; it differs from conventional push systems, such as real time push e-mail, because the data received by the device is not merely stored and accessible within a single application that is dedicated to data acquisition and display, such as a messaging application for push e-mail or a web or WAP browser. Nor is it stored and accessible outside of a specific application in the way that, for example, a SMS alert “You have I message” is displayed on the standby or idle screen of a mobile telephone. Instead, the data received by the device is displayed, as noted above, within a running application that is not limited to displaying only data from the specific remote service provider, or to data of the kind supplied by the data service provider, but is instead a more general application that nevertheless provides an appropriate and relevant context in which to automatically embed the icon.

The data from the remote service provider may be pushed to the device whenever the associated data changes, or at regular times or at pre-defined time intervals. This may be done without charge. Similarly, it may also be pulled by the device at regular or pre-defined time intervals as a background, automatic process, or the pull may be manually initiated by the user. The data may also arrive at the device through a synchronisation process. The more detailed information accessed only after a user has selected an icon embedded within an application may be supplied on a fee basis (e.g. subscription or pay per use). Hence, the present invention contemplates in one implementation a combined push/pull model, with ‘free’ push data acting as an inducement to the user to pull down data that is paid for by the user.

Data can also be ‘beamed’ or otherwise distributed between end user wireless information devices, enabling the viral spreading of services. Hence, a user with for example access to a football scoring service as represented by an appropriate icon, can beam the associated object to a friend's device, which in turn enables the friend's device to receive the football scoring service, perhaps subject to the friend entering into an applicable subscription service, and subject also to the friend explicitly accepting the beamed object, which may involve authenticating the sender. The data may be in biomessage or smart message format. In practice, this may be achieved by the user being given an option when selecting an icon to ‘beam’ that icon. Selecting the ‘beam’ option then automatically opens up a messaging application, with the object for the recipient to obtain access to the data service being automatically made the biomessage payload for that message.

A ‘gateway’ server can be used to receive data from data services providers or publishers, rather than the data being sent to an end user device without any kind of intermediary which stores or manipulates data. The server can act as a virtual representation of the client device. It can receive content even when the device is not available. The server provides a common interface for all service publishers and hence decouples the details of the handset from the content provider and allows a number of “virtual devices” to be defined against which the content providers can deliver content. It is the gateway server's responsibility to convert the content into a form that the client can handle and then deliver it to the client. This is a major advantage to both service publishers and content providers as it creates a virtual handset platform in the market. The gateway server maintains a log of all content delivered to the handset. It is able then to bill the content publisher appropriately. The gateway server also gains information about the customer base, which forms a valuable CRM database for managing content to the client device. The gateway server has access to directory information that allows the user to select services more effectively.

The gateway server handles provisioning the client and the plug-ins and certificates that will be needed. This takes much of the authentication problem away from the client device. Integration of content into the device in this way provides an “embedded portal” within which related content such as that found on a portal can be presented to the user in a compelling manner. The gateway server is a natural location for presence information and the services associated with it. The model is entirely consistent with the “web services” model that is emerging in the market and provides the front-end interface to such web services.

For convenience and flexibility, the user may be able to manage service subscriptions from an application on the device itself and to ensure data integrity any alterations made should initiate a call to the gateway server and the changes mirrored in the CRM. In addition as new services are added to the gateway server they should also be made available on the device application thus keeping the gateway server and the application synchronised Further details and aspects are defined in the appended Claims.

### BRIEF DESCRIPTION OF THE DRAWINGS

The present invention will be described with reference to the accompanying drawings, in which:

FIGS. 1-5 depict a smart phone; the display illustrates the operation of the present invention;

FIG. 6 is a schematic of major system components, including the Content Manager on a smartphone device;

FIG. 7 is a schematic of major components in a server based implementation of the present invention;

FIG. 8 is a schematic of the revenue model possible with the present invention.

### DETAILED DESCRIPTION

The ADSF or Advanced Data Services Framework is a technology developed within Symbian Limited of London, United Kingdom to support the effective deployment of certain types of services on advanced mobile phones. It is commercially implemented in a system called Magpie.

The Market Need

The ADSF addresses the emerging market for wireless data-enabled phone devices (smartphones and PDAs). There are broadly two revenue models for these devices, communication based (calling, messaging, email, . . . ) and content based (news and information, media, m-commerce, . . . ). The initial mobile phone market has shown that the communication aspects of the devices are very successful—in Europe, over 99% of mobile phone revenues are derived from voice calls and messaging (Vodafone, 2001). However, many operators see data services as the way to further enhance revenues as mobile communications become more commoditised. Vodafone (Vodafone, 2001) and Orange (Orange share prospectus, 2001) both envision data revenues comprising 25-35% of total revenue in 2005. In reality, the “data access” component covers a number of services including m-commerce and is not just corporate data access:

The ADSF

The ADSF turns around the browsing paradigm. Instead of the user searching for content, the content is brought to the user in context. So, if the user is looking at their calendar application on the phone, services that are relevant to the calendar such as weather or perhaps sports will be available in an unobtrusive way within the application. The calendar application is not aware of the content itself—it simply acts as a host for the content. In this way, the content can be changed without changing the host application. This is best described with an example:

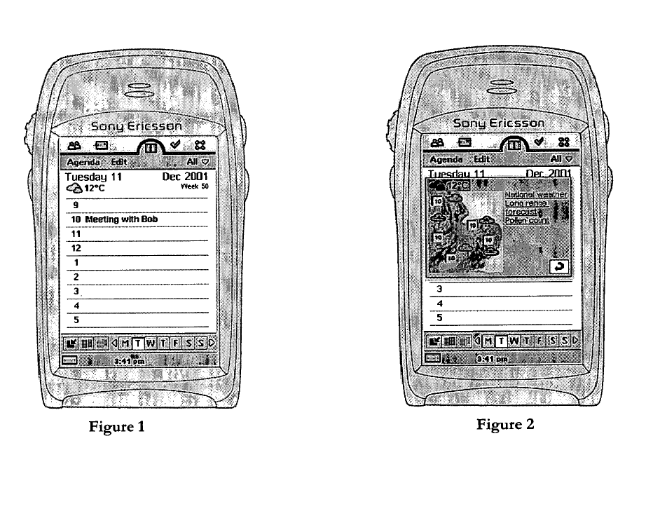

A weather icon is displayed in the calendar application, as shown as the small cloud and the ‘12° C.’ below the factual text ‘Tuesday 11’ in FIG. 1. The icon changes dynamically to represent the weather on the particular day. Clicking on the icon causes a new application to be launched that takes the user to more detailed weather information as shown in FIG. 2. The user may well pay a small sum (charged automatically to the phone bill) for this additional information. FIG. 2 shows a map of Eastern England with weather symbols and temperatures superimposed over the applicable parts of the country. In addition, three additional links to further pay based information services are provide:
National Weather
Long Range Forecast
Pollen Count

Again, the user would likely have to pay a small sum to access this more detailed information.

Using the folder list, the user can ‘filter’ which services are currently displayed in the current application, as shown in FIG. 3. Here, the folder lists is a menu of the following options:
All
Personal
Work
Sport
Entertainment
TV Guide

The folder list is a convenient menu in which to place the service ‘filters’.

Selecting ‘Sport’ in the drop down menu folder list will show information from Sky Sports services, including football match objects, as shown in FIG. 4; a football match between Arsenal and Leeds

Tapping on the football match icon allows the user to see match information and download highlights, as shown in FIG. 5. As before, this would be on a pay basis. Additional links to further pay for data are also included:
Full Story
Download Highlights

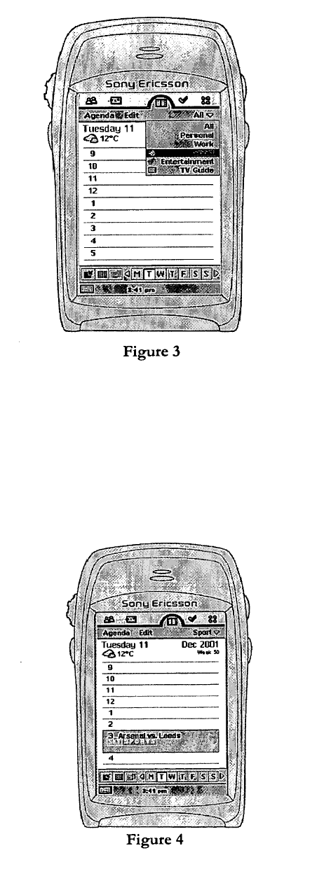

Architecturally, the ADSF can be thought of as adding an intelligent data store and data router onto the device (the content manager), as shown in FIG. 6. The content manager is responsible for receiving or gathering content according to the user's requirements and publishing it into defined areas of the main applications on the device. The content is likely to be delivered as standard WAP/WEB formats. The content manager insulates or separates the different applications from interfacing directly with the components or other software running on the device which acquires the data. Further details on the content manager are in PCT/GB01/03788 to Symbian Limited, which is incorporated by reference into this specification.

This example is a simple demonstration of the capability provided by the ADSF. Even in this simple case, it has addressed a number of usability issues:
The user is able to access content from the native applications on the phone. There is no need to navigate to a separate browser application.
The user no longer has to navigate a deep WAP tree—the frequently required content is available at or close to the top level.
Content may be branded according to the phone supplier allowing network operators or others to improve their contact with the customer
The user experience is improved, increasing the rate of use of (and hence revenue from) the services.
   Roll-Out Model

The roll out model is critical to any wireless data service. For the ADSF to be successful, a number of interrelated factors are required:
A sufficient community of handsets supporting the technology to encourage content providers
A sufficient quantity of content to make the service compelling to users
Sufficient pull from the operators to encourage the handset manufacturers to incorporate the technology in their devices

These are supported by the following:
Simple format for data based on a standard protocol (XHTML) allowing content providers to make their content available in a well-understood way.
A small base content manager with the ability for the user to add further functionality (such as advanced preferences support) later as add-ons to their device. In this way the memory footprint within the standard phone is minimised so reducing the cost increment to handset manufacturers to a small level.
Commercial relationships with key content providers, operators and handset manufacturers to support the technology.
   Revenue Model

The revenue model from this approach is not simple. It may be possible to make a small charge for the base content manager to the handset manufacturer. This is likely to be of the order of 5-10 c/handset but over millions of units this could represent a reasonable source of revenue. It would be possible to sell additional client capabilities that provide a richer user experience to service and content providers (particularly network operators). This could provide either per handset or usage revenues. However, this implies access to the billing systems of the operators and agreement regarding a suitable revenue share (both of which are possible but difficult to put in place).

Alternative Revenue models include
Content providers may provide premium services whereby a user pays an upfront subscription charge for a given period of time and in exchange receives the initial and additional content without incurring any additional cost.
Content providers may charge a user for the initial limited information through a basic subscription charge and then charge for any additional information that is pulled.
   Extending the ADSF

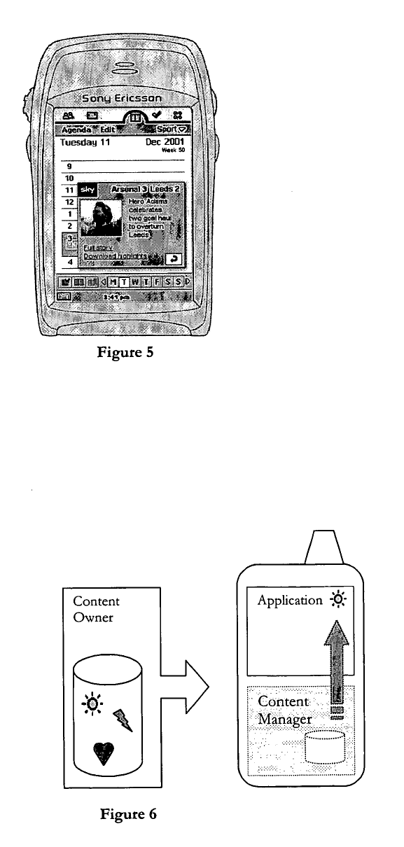

So far, the ADSF has been thought of as a client only technology. However, there are advantages to introducing a server component as well, as shown as the ADSF Gateway Server in FIG. 7. In this model, content is assumed to be provided by Service Publishers. A service publisher has a billing relationship with the customer and delivers content from a content owner. Frequently, the operators may act as service publishers or other third parties may take on this role. Since the publisher is the body receiving revenue directly for the service, they are the most appropriate body to charge for delivery of additional service revenues.

The addition of the server provides a number of substantial advantages:
The server can act as a virtual representation of the client device. It can receive content even when the device is not available.
The server provides a common interface for all service publishers. While initially, the most likely service publishers are the network operators, the system enables other service publishers such as those with an existing billing relationship with the customer (e.g. Sky, Tesco) or those that have non-billing revenue models (e.g. the BBC).
The server decouples the details of the handset from the content provider and allows a number of “virtual devices” to be defined against which the content providers can deliver content. It is the gateway server's responsibility to convert the content into a form that the client can handle and then deliver it to the client. This is a major advantage to both service publishers and content providers as it creates a virtual handset platform in the market (the creation of a standardised mobile phone platform for service delivery has been a “holy grail” within the industry for some time).
The Gateway server maintains a log of all content delivered to the handset. It is able then to bill the content publisher appropriately.
The gateway server gains information about the customer base, which forms a valuable CRM database for managing content to the client device.
The gateway server has access to directory information that allows the user to select services more effectively.
The gateway server handles provisioning the client and the plug-ins and certificates that will be needed. This takes much of the authentication problem away from the client device.
Integration of content into the device in this way provides an “embedded portal” within which related content such as that found on a portal can be presented to the user in a compelling manner.
The gateway server is a natural location for presence information and the services associated with it.
The model is entirely consistent with the “web services” model that is emerging in the market. The ADSF provides the front-end interface to such web services.
   Service Selection, Provisioning and Distribution

Services can be thought of as lightweight objects that reside on the device and provide links to other (probably revenue-bearing) services. Services can be provisioned on a device either by user selection (pull) or by provisioning (push). In addition, it is possible for a user to “send” a service from one device to another. If the new user is authenticated to receive the value-added services then they will pay for them in the normal way when they click on the icon, otherwise there will be a means of encouraging them to subscribe. This enables viral distribution of services and eliminates the need for complex Digital Rights Management (RDM) technology.

Revenue Model

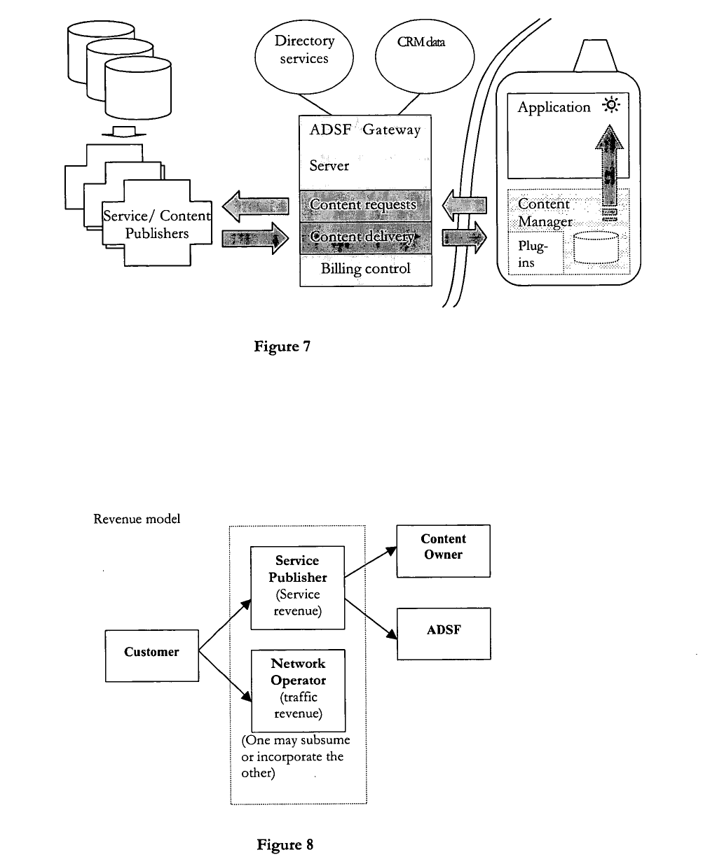

The revenue model in this case is rather more compelling, as shown in FIG. 8. It is assumed that the publishers will be delivering content from which they gain value. The gateway server monitors the traffic and bills the publishers a proportion of the transaction cost of the data. Generally, these will be small payments for each service and since they are associated with direct revenue to the service publishers, it is believed that publishers will accept this in return for additional service revenue and a simpler route to the client. This is analogous to the charge made by credit card companies for purchase transactions.

Advantages to content providers/network operators/service publishers:
Provides a single interface for content, independent of the device in question
Creates incremental service revenue
Allows branding of a device in terms of the services delivered
Billing is based on a cut of the overall service revenue therefore easy to justify

Advantage for handset manufacturers
Expands the attractiveness of the device because of the wide range of content supported
Integration with server allows device-specific enhancements to be supported
Minimum footprint software inclusion

Advantages to user
Content arrives in a compelling manner
Displayed in the optimum way on each phone

Advantages to new entrants
The framework provides a model for delivering content that does not need to include the network operator
Supports monetised services over distribution channels other than over the air (e.g. Bluetooth, 802.11)
   Extending Beyond SymbianOS Phones

The content manager can be ported to other devices including other phones, PDAs and even PCs. A more limited version may be able to be ported to simpler phones with a likely base level requirement of a packet network and a browser interface.

The gateway server may be extended to provide a legacy phone interface, e.g. by providing content over SMS/MMS or via WAP/WEB. In this way, the content can be made available to the existing population of legacy phones, albeit with a greatly reduced interface and utility.

Target Markets

There are a number of approaches from a market standpoint.
Corporates represent an attractive initial market. The ADSF allows company-specific information to be made available on phone devices, for instance real time alerts, Intranet facilities, purchasing (hotels etc) through company channels etc. This is equivalent to embedding the company's Intranet within the phone's applications. May require authentication and secure transaction plug-ins.
Operators are attractive, particularly those with their own portals that want to get close to the customer. Using the framework, they can brand the phone to a large degree and make their services the default choices within applications.
MVNOs and major brand/content providers will also be attracted by the ability to deliver content to customers in a targeted way. This allows them in principle to offer services without involving a specific network operator.
   Market Penetration

The USPs of the ADSF are:
Ability to present hooks for content to the customer in a way that they are likely to respond to
Simplified interface for content publisher to a variety of target handsets
A viral distribution model without the need for a complicated DRM system
Increased traffic for monetised services
An extensible framework for key services such as authentication

A key issue to market uptake and revenue return is the trade-off between open and proprietary standards for the content. As a rule, open standards are greatly preferred as long as there are practical ways to avoid disintermediation.

The main stages in content delivery within the ADSF are:
Creation of icons etc to present to the user (this will be a small number of generic icons)
Provisioning the device
Presenting the icons in context
Following activation of an icon, following an appropriate link to content
<Optional device/owner identification>
<Optional content translation for the device>
Content delivery and display

The challenge with a revenue share model is to avoid disintermediation. On the other hand, proprietary solutions will make acceptance of the roll-out model difficult.

Proposed Model

The base level client content manager software should be free of charge. This software allows content to be delivered and displayed in an application with limited user selection of content. This should be deployed in the maximum possible number of client devices. There should be open standards for the icon content and for provisioning the device (with a suitable security model). These should be simple standards e.g. bitmaps and links. The client should not expect to apply significant intelligence to the display of bitmaps or content.

There should be an open plug-in model that allows more capable content managers to be deployed (either at time of manufacture of over the air). These may have proprietary connection to the server.

The server is offered as a service (provided or more likely licensed through partners) that:
Provisions devices depending on the client
Filters content depending on the client
Provides a uniform interface
Provides billing and CRM statistics as appropriate

In summary, the model is:
1. Widespread adoption of the simple client. This allows icons to be placed in applications and provide back links.
2. Offer of an incremental client-server pair that offers authentication, billing, etc. or power source.

1. A method of displaying data on a wireless information device, in which data supplied from a remote data supplier is automatically displayed within an application running on the device, and changes to alert the user to new data or to represent that new data;
characterised in that the device is programmed to present a menu list of the different data types already stored on the device and potentially available within a given application, such that selecting a particular data type from the menu list causes data of the selected type to be automatically displayed within that application.

2. The method of claim 1 in which the application is not an application that is dedicated to data acquisition from servers remote from the device, such as a messaging application for push e-mail or a web or WAP browser.

3. The method of claim 2 in which the application enables the device to display and manipulate data of a different kind from the data associated with the data from the remote service provider.

4. The method of claim 3 in which the application provides appropriate and relevant factual information in which to automatically embed the data from the data supplier.

5. The method of claim 1 in which the step of a user clicking on the icon causes a new application to be launched that takes the user to more detailed related information.

6. The method of claim 1 in which the data is pushed to the device.

7. The method of claim 6 in which the data is pushed to the device whenever the associated source data changes, or at regular times or at pre-defined time intervals.

8. The method of claim 5 in which the detailed information is pulled by the device.

9. The method of claim 8 in which the data from the remote data supplier is pulled by the device at regular or pre-defined time intervals as a background, automatic process, or using a pull that is manually initiated by the user.

10. The method of claim 8 in which pushed data is supplied without charge to the user and the pulled detailed information is supplied on a pay basis.

11. The method of claim 1 in which the same data is presented within several different applications.

12. The method of claim 11 in which data is handled at the device by a content manager layer which insulates or separates the different applications from interfacing directly with the components or other software running on the device which acquires the data.

13. The method of claim 1 in which the data displayed on the device is represented as a small, stylised representational graphic or image.

14. The method of claim 1 in which the data comprises text.

15. The method of claim 1 in which the data can be shared between several wireless information devices.

16. The method of claim 1 in which the data displayed on the device is a sub-set of a software object.

17. The method of claim 16 in which several different icons are sub-sets of the same software object.

18. The method of claim 16 in which the object is accessible by several different applications.

19. The method of claim 16 in which the object has several different data variables associated with it.

20. The method of claim 16 in which the object attaches to pre-existing objects in an application.

21. A wireless computing device programmed to display data from a remote data provider, in which data supplied from a remote data supplier is automatically displayed within an application running on the device and changes to alert the user to new data or to represent that new data;
characterised in that the device is programmed to present a menu list of the different data types already stored on the device and potentially available within a given application, such that selecting a particular data type from the menu list causes data of the selected type to be automatically displayed within that application.

22. Computer software which enables a wireless computing device to display data, in which data supplied from a remote data supplier is automatically displayed within an application running on the device and changes to alert the user to new data or to represent that new data;
characterised in that the software is programmed to present a menu list of the different data types already stored on the device and potentially available within a given application, such that selecting a particular data type from the menu list causes data of the selected type to be automatically displayed by the software within that application.
